(19) United States
(12) Patent Application Publication
(10) Pub. No.: US 2024/0071213 A1
(43) Pub. Date: Feb. 29, 2024

(54) INFORMATION PROCESSING APPARATUS, INFORMATION PROCESSING METHOD, AND SYSTEM

(71) Applicant: TOYOTA JIDOSHA KABUSHIKI KAISHA, Toyota-shi (JP)

(72) Inventor: Shinya HIROSAWA, Nisshin-shi (JP)

(73) Assignee: TOYOTA JIDOSHA KABUSHIKI KAISHA, Toyota-shi (JP)

(21) Appl. No.: 18/364,035

(22) Filed: Aug. 2, 2023

(30) Foreign Application Priority Data
Aug. 30, 2022 (JP) 2022-136622

(51) Int. Cl. G08G 1/01; G06V 20/58; G08G 1/052

(52) U.S. Cl. CPC G08G 1/0133; G06V 20/58; G08G 1/0112; G08G 1/052

(57) ABSTRACT

A controller configured to perform: identifying, based on position information and speed information of each vehicle obtained from a plurality of vehicles traveling on a road having a plurality of lanes, a first section in which a part of the lanes among the plurality of lanes is congested; obtaining image data that has captured the first section thus identified; and identifying a congested lane in the first section based on the image data.

### CROSS REFERENCE TO THE RELATED APPLICATION

This application claims the benefit of Japanese Patent Application No. 2022-136622, filed on Aug. 30, 2022, which is hereby incorporated by reference herein in its entirety.

### BACKGROUND

### Technical Field

The present invention relates to an information processing apparatus, an information processing method, and a system.

### Description of the Related Art

Patent Literature 1 discloses a technology related to a congestion information creation device. This congestion information creation device collects probe information including position information from probe cars, and detects a congested lane and a congestion line in the congested lane based on this probe information.

### CITATION LIST

### Patent Literature

Patent Literature 1: Japanese Patent Application Laid-Open Publication No. 2008-210123

### SUMMARY

An object of the present invention is to detect a congested lane in a road having a plurality of lanes.

One aspect of the present invention is directed to an information processing apparatus including a controller configured to perform:
identifying, based on position information and speed information of each vehicle obtained from a plurality of vehicles traveling on a road having a plurality of lanes, a first section which is a section where a part of the plurality of lanes is congested;
obtaining image data that has captured the first section thus identified; and
identifying a congested lane in the first section based on the image data.

Another aspect of the present invention is directed to an information processing method for causing a computer to perform:
identifying, based on position information and speed information of each vehicle obtained from a plurality of vehicles traveling on a road having a plurality of lanes, a first section which is a section where a part of the plurality of lanes is congested;
obtaining image data that has captured the first section thus identified; and
identifying a congested lane in the first section based on the image data.

A further aspect of the present invention is directed to a system comprising:
a plurality of vehicles configured to transmit their position information and speed information; and
a server configured to receive the position information and the speed information from the plurality of vehicles; wherein
the server is configured to perform:
identifying, based on the position information and the speed information of each vehicle obtained from the plurality of vehicles traveling on a road having a plurality of lanes, a first section that is a section where a part of the plurality of lanes is congested;
transmitting, to the plurality of vehicles, a command to provide image data that has captured the first section thus identified;
obtaining the image data from the plurality of vehicles; and
identifying a congested lane in the first section based on the image data.

In addition, a still further aspect of the present invention is directed to a program for performing the above-described method, and a computer readable storage medium storing the program in a non-transitory manner.

According to the present invention, it is possible to detect a congested lane in a road having a plurality of lanes.

### BRIEF DESCRIPTION OF THE DRAWINGS

FIG. 1 is a view illustrating a schematic configuration of a system according to an embodiment;

FIG. 2 is a view for explaining an outline of the processing of the system;

FIG. 3 is another view for explaining the outline of the processing of the system;

FIG. 4 is a further view for explaining the outline of the processing of the system;

FIG. 5 is a still further view for explaining the outline of the processing of the system;

FIG. 6 is a block diagram schematically illustrating an example of a configuration of each of a vehicle terminal and a server, which together constitute the system according to the embodiment;

FIG. 7 is a diagram illustrating an example of a functional configuration of the server;

FIG. 8 is a view illustrating an example of a table structure of a travel information DB;

FIG. 9 is a view illustrating an example of a table structure of an image information DB;

FIG. 10 is a view illustrating an example of a table structure of a congestion information DB;

FIG. 11 is a sequence diagram illustrating the overall processing of the system;

FIG. 12 is a flowchart illustrating the processing of identifying a first section by the server according to a first embodiment;

FIG. 13 is a flowchart illustrating the processing of identifying a congested lane by the server; and

FIG. 14 is a flowchart illustrating the processing of identifying a first section by a server according to a second embodiment.

### DESCRIPTION OF THE EMBODIMENTS

In a road having a plurality of lanes, a part or some of the lanes may be congested. For example, even if there is traffic congestion in a right-turn lane or a left-turn lane, there may be no congestion in a straight-ahead lane. Also, for example, due to the congestion of a parking lot in a store, vehicles waiting for a vacant parking space may line up to a road or street, so that only the leftmost lane or the rightmost lane may be congested. Here, for example, it is also conceivable to identify a lane in which traffic congestion is occurring by locating the position of each vehicle by using a GPS device mounted on the vehicle. However, since the GPS device mounted on each vehicle has low accuracy in detecting the position thereof, it may be difficult to identify the lane in which the vehicle is traveling. In addition, it is also conceivable to obtain image data from vehicles to identify the lane in which traffic is congested. However, it is not realistic to constantly try to obtain image data captured by vehicles, as the amount of communication traffic would be enormous.

In order to solve such a problem, an information processing apparatus, which is one aspect of the present invention, includes a controller configured to perform: identifying, based on position information and speed information of each vehicle obtained from a plurality of vehicles traveling on a road having a plurality of lanes, a first section in which a part of the lanes among the plurality of lanes is congested; obtaining image data that has captured the first section thus identified; and identifying a congested lane in the first section based on the image data.

In other words, the amount of communication traffic can be further reduced by identifying a section where a part of the lanes is congested (first section) based on the position information and the speed information whose amount of information is small, and obtaining the image data only for the first section. When identifying the first section based on the position information and the speed information, it is not possible to identify a lane in which traffic is congested. However, if the image data related to the first section thus identified is obtained from the vehicles, it is possible to obtain the image data with a relatively small amount of communication. Then, the image data can be analyzed to identify the lanes congested in the first section.

Here, note that the section may be, for example, a section obtained by dividing the road by a predetermined distance (e.g., 100m), or may be, for example, a section between traffic lights or between intersections.

In addition, for example, image data captured by a drive recorder can be used for the image data. The vehicles providing the image data are not limited to the vehicles that provided the position information and the speed information for identifying the first section. The vehicles providing the image data may be, for example, vehicles that subsequently pass through the first section, vehicles that previously passed through the first section, or vehicles that are currently located in the first section. By performing image analysis based on the image data thus obtained, it becomes possible to identify congested lanes among the plurality of lanes.

Hereinafter, embodiments of the present invention will be described based on the accompanying drawings. The configurations of the following embodiments are examples, and the present invention is not limited to the configurations of the embodiments. In addition, the following embodiments can be combined with one another as long as such combinations are possible and appropriate.

### First Embodiment

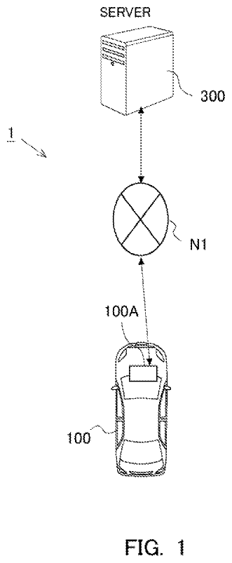

FIG. 1 is a view illustrating a schematic configuration of a system 1 according to an embodiment. In the example of FIG. 1, the system 1 includes a vehicle terminal 100A mounted on a vehicle 100, and a server 300. The vehicle terminal 100A and the server 300 are mutually connected to each other by a network N1. Here, note that the network N1 is, for example, a worldwide public communication network such as the Internet or the like, and a WAN (Wide Area Network) or other communication networks may be adopted. Also, the network N1 may include a telephone communication network such as a mobile phone network or the like, and/or a wireless communication network such as Wi-Fi (registered trademark) or the like. Note that in FIG. 1, one vehicle 100 is illustrated, but there are a plurality of vehicles 100. The vehicle 100 is, for example, a connected car that can communicate with the outside.

The system 1 identifies the lanes of a road in which traffic congestion is occurring, based on information about speed (hereinafter referred to as “speed information”), information about position (hereinafter referred to as “position information”), and image data transmitted from a plurality of vehicles 100, and provides, to the vehicles 100, for example, the information about the lanes thus identified in which the traffic congestion is occurring. The server 300 identifies a section of the road (i.e., a first section) in which congestion is occurring in a part or some of the lanes of the road according to the speed and position of each vehicle 100 obtained via its vehicle terminal 100A. Then, the server 300 transmits a command to the vehicles 100 that are about to pass through the first section, the vehicles 100 that have passed through the first section in the past, or the vehicles 100 that are located in the first section at the current time point, so as to transmit image data capturing the road. Further, the image data of the first section transmitted from the vehicles 100 is analyzed to identify the lanes in which traffic congestion is occurring. The information about the congested lanes thus identified is transmitted to, for example, the vehicles 100 present in an area including the first section. This information is displayed, for example, on a display of a navigation device of each vehicle 100. Also, as an alternative, this information may be provided to a server that provides congestion information, or may be provided to a display device that is arranged at a roadside to guide congested locations. The information provided to the vehicles 100 or the like includes information capable of identifying the section in which traffic is congested and information capable of identifying the lanes in which traffic is congested.

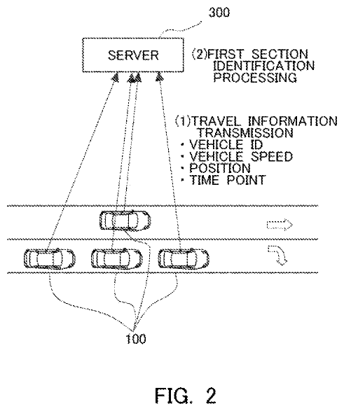

Here, the overall processing of the system 1 will be described based on FIGS. 2 through 5. FIGS. 2 through 5 are views for explaining an outline of the processing of the system 1. In FIG. 2, travel information is transmitted from the plurality of vehicles 100 to the server 300 at predetermined time intervals, as indicated by (1). The travel information includes identification information (vehicle ID) for identifying each vehicle 100, and information about the speed of each vehicle 100 (vehicle speed), the position of each vehicle 100, and the time (i.e., time point). In FIG. 2, the server 300 performs first section identification processing based on the travel information received from the plurality of vehicles 100, as indicated by (2). The first section identification processing is processing of identifying the section in which congestion is occurring in a part of the lanes.

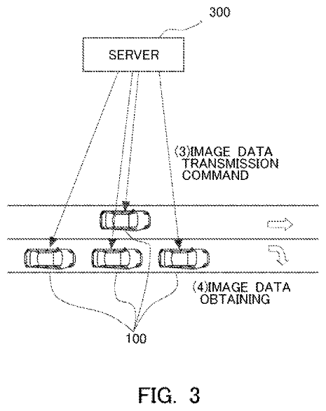

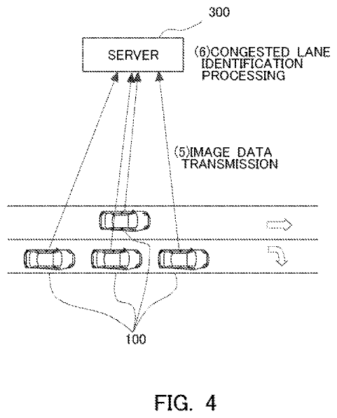

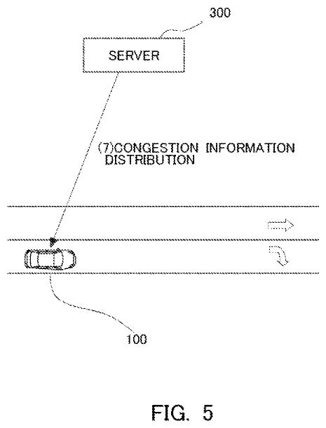

In FIG. 3, a command to transmit image data is sent to the vehicles 100 that have traveled through the first section thus identified, as indicated by (3). Then, based on the command from the server 300, the vehicles 100 obtain the image data of the road around the vehicles 100, as indicated by (4). Further, in FIG. 4, the image data are transmitted from the vehicles 100 to the server 300, as indicated by (5), and the server 300 performs the congested lane identification processing based on the image data received from the vehicles 100, as indicated by (6). The congested lane identification processing is processing of identifying a lane(s) in which traffic is congested in the first section. In FIG. 5, the server 300 distributes congestion information, for example, to the vehicles 100 that are present within a predetermined distance from the first section, as indicated by (7). The congestion information includes information about the first section and information about a lane(s) in which traffic is congested.

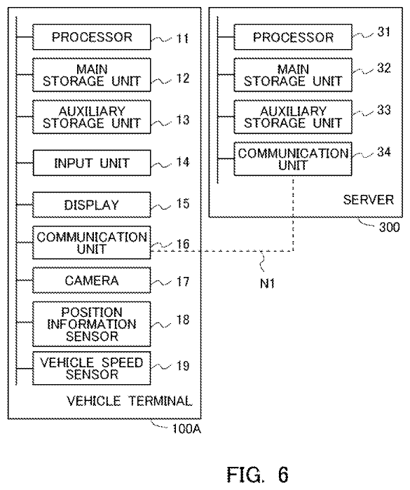

Next, hardware configurations of the vehicle terminal 100A of the vehicle 100 and the server 300 will be described based on FIG. 6. FIG. 6 is a block diagram schematically illustrating an example of a configuration of each of the vehicle terminal 100A and the server 300, which together constitute the system 1 according to the present embodiment.

The server 300 has a configuration of a computer. The server 300 includes a processor 31, a main storage unit 32, an auxiliary storage unit 33, and a communication unit 34. These components are mutually connected to one another by means of a bus. Note that the processor 31 is an example of a controller.

The processor 31 is a CPU (Central Processing Unit), a DSP (Digital Signal Processor), or the like. The processor 31 controls the server 300 thereby to perform various information processing operations. The main storage unit 32 is a RAM (Random Access Memory), a ROM (Read Only Memory), or the like. The auxiliary storage unit 33 is an EPROM (Erasable Programmable ROM), a hard disk drive (HDD), a removable medium, or the like. The auxiliary storage unit 33 stores an operating system (OS), various programs, various tables, and the like. The processor 31 loads a program stored in the auxiliary storage unit 33 into a work area of the main storage unit 32 and executes the program, so that each component or the like is controlled through the execution of the program. As a result, the server 300 realizes functions that match predetermined purposes. The main storage unit 32 and the auxiliary storage unit 33 are computer readable recording media. Here, note that the server 300 may be a single computer or a plurality of computers that cooperate with one another. In addition, the information stored in the auxiliary storage unit 33 may be stored in the main storage unit 32. Also, the information stored in the main storage unit 32 may be stored in the auxiliary storage unit 33.

The communication unit 34 is a means or unit that communicates with the vehicle terminal 100A via the network N1. The communication unit 34 is, for example, a LAN (Local Area Network) interface board, a wireless communication circuit for wireless communication, or the like. The LAN interface board or the wireless communication circuit is connected to the network N1.

Now, the vehicle terminal 100A will be described. The vehicle terminal 100A is configured to include, for example, a navigation device. The vehicle terminal 100A has a processor 11, a main storage unit 12, an auxiliary storage unit 13, an input unit 14, a display 15, a communication unit 16, a camera 17, a position information sensor 18, and a vehicle speed sensor 19. These components are mutually connected to one another by means of a bus. The processor 11, the main storage unit 12 and the auxiliary storage unit 13 are the same as the processor 31, the main storage unit 32 and the auxiliary storage unit 33 of the server 300, respectively, and hence, the description thereof will be omitted.

The input unit 14 is a means or unit for receiving an input operation performed by a user, and is, for example, a touch panel, a mouse, a keyboard, a push button, or the like. The display 15 is a means or unit that presents information to the user, and is, for example, an LCD (Liquid Crystal Display), an EL (Electroluminescence) panel, a speaker, a lamp, or the like. The input unit 14 and the display 15 may be configured as a single touch panel display. The communication unit 16 is a communication means or unit for connecting the vehicle terminal 100A to the network N1. The communication unit 16 is a circuit for communicating with another device (e.g., the server 300 or the like) via the network N1 by making use of a mobile communication service (e.g., a telephone communication network such as 6G (6th Generation), 5G (5th Generation), 4G (4th Generation), 3G (3rd Generation), LTE (Long Term Evolution) or the like), and/or a wireless communication network such as Wi-Fi (registered trademark), Bluetooth (registered trademark) Low Energy, NFC (Near Field Communication), UWB (Ultra Wideband) or the like.

The camera 17 is a means of photographing or capturing an area around the vehicle 100. The camera 17 serves to capture images by using an imaging device such as a CCD (Charge Coupled Device) image sensor, a CMOS (Complementary Metal Oxide Semiconductor) image sensor or the like. The images obtained by photographing or capturing may be either still images or moving images. The position information sensor 18 obtains position information of the vehicle 100 at a predetermined interval or cycle. The position information sensor 18 is, for example, a GPS (Global Positioning System) receiver unit, a wireless communication unit or the like. The vehicle speed sensor 19 is a sensor that detects the speed of the vehicle 100.

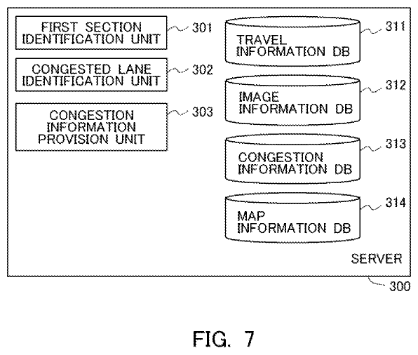

Then, the functions of the server 300 will be described. FIG. 7 is a diagram illustrating an example of a functional configuration of the server 300. The server 300 includes, as functional components, a first section identification unit 301, a congested lane identification unit 302, a congestion information provision unit 303, a travel information DB 311, an image information DB 312, a congestion information DB 313, and a map information DB 314. The processor 31 of the server 300 performs the processing of the first section identification unit 301, the congested lane identification unit 302, and the congestion information provision unit 303 by executing a computer program on the main storage unit 32. However, any of the individual functional components or a part of the processing thereof may be implemented by a hardware circuit.

The travel information DB 311, the image information DB 312, the congestion information DB 313, and the map information DB 314 are built by a program of a database management system (DBMS) that is executed by the processor 31 to manage data stored in the auxiliary storage unit 33. The travel information DB 311, the image information DB 312, the congestion information DB 313, and the map information DB 314 are, for example, relational databases.

The first section identification unit 301 obtains the travel information of the vehicles 100 and identifies the first section based on the travel information of the plurality of vehicles 100. The travel information includes information about the vehicle ID, the vehicle speed, the position, the time, etc., of each vehicle. The travel information is transmitted from the vehicle terminal 100A of each vehicle to the server 300. When obtaining the travel information, the first section identification unit 301 stores the travel information thus obtained in the travel information DB 311 which will be described later.

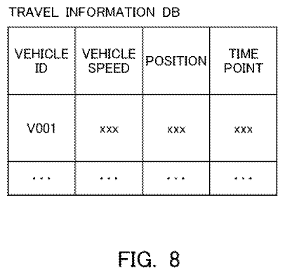

Here, FIG. 8 illustrates an example of a table structure of the travel information DB 311. The travel information table has fields for vehicle ID, speed, position, and time. In the vehicle ID field, information for identifying each vehicle 100 is entered. In the vehicle speed field, information about the speed of each vehicle 100 is entered. The information about the speed of each vehicle 100 includes information about the detected value of the vehicle speed sensor 19 thereof. In the position field, information about the position of each vehicle 100 is entered. The information about the position of each vehicle 100 includes information about the detected value of the position information sensor 18 thereof. In the time field, information about time (i.e., time point) at which the vehicle speed and the position of each vehicle 100 was obtained is entered. Here, note that, as an alternative, in the time field, the time at which information about the vehicle ID, the vehicle speed, and the position of each vehicle 100 was received from the vehicle 100 may be entered.

Further, the first section identification unit 301 determines whether or not a section of a road is congested, based on the speeds of the plurality of vehicles 100 traveling in the same section of the road. Here, if there is no speed difference between the lanes in the section, it cannot be said that congestion is occurring in a part of the lanes. For example, when a speed difference between the lanes is sufficiently small, it can be said that there is no congestion or that all the lanes are congested. That is, in cases where only a part of the plurality of lanes is congested, a speed difference between the vehicles 100 passing through the non-congested lanes and the vehicles 100 passing through the congested lanes increases.

Therefore, the first section identification unit 301 identifies, as the first section, a section in which the proportion of the number of vehicles whose vehicle speeds are equal to or lower than a first speed is equal to or greater than a first threshold value and the proportion of the number of vehicles whose vehicle speeds are equal to or higher than a second speed is equal to or greater than a second threshold value, among the plurality of vehicles 100 traveling in the same section. This second speed is higher than the first speed. The first speed is an upper limit value of the vehicle speed in the case where the vehicles 100 pass through lanes in which traffic congestion is occurring, and the second speed is a lower limit value of the vehicle speed in the case where the vehicles 100 pass through lanes in which traffic congestion is not occurring. The first vehicle speed and the second vehicle speed may be set according to, for example, the speed limit of the road. That is, the higher the speed limit of the road, the higher the first vehicle speed and the second vehicle speed may be made.

In addition, in cases where traffic congestion is occurring in a part of the lanes, the first threshold value is set as a lower limit value for the proportion of vehicles 100 passing through lanes in which congestion is occurring, among a plurality of vehicles 100 traveling in the same section. Also, in cases where congestion is occurring in a part of the lanes, the second threshold value is set as a lower limit value for the proportion of vehicles 100 passing through lanes in which congestion is not occurring, among a plurality of vehicles 100 traveling in the same section. The first threshold value and the second threshold value are proportions of the number of vehicles 100 for which it can be determined that congestion is not occurring in a part of the lanes. The first threshold value and the second threshold value are greater than zero. The first vehicle speed, the second vehicle speed, the first threshold value, and the second threshold value may be set for each of a plurality of sections of the road. The first vehicle speed, the second vehicle speed, the first threshold value, and the second threshold value have been stored in the auxiliary storage unit 33.

Here, note that in the present embodiment, it is determined based on the proportion of the number of vehicles 100 whether or not traffic congestion is occurring, but as an alternative, it may be determined based on the number of vehicles 100 whether or not traffic congestion is occurring. For example, the first section identification unit 301 identifies, as the first section, a section in which the number of vehicles whose vehicle speeds are equal to or lower than the first speed is equal to or greater than the first threshold value and the number of vehicles whose vehicle speeds are equal to or higher than the second speed is equal to or greater than the second threshold value, among a plurality of vehicles 100 traveling in the same section.

For each section of the road, the first section identification unit 301 determines, at each predetermined time interval, whether or not the proportion of the number of vehicles whose vehicle speeds are equal to or lower than the first speed is equal to or greater than the first threshold value, and whether or not the proportion of the number of vehicles whose vehicle speeds are equal to or higher than the second speed is equal to or greater than the second threshold value, among a plurality of vehicles 100 traveling in each section. Since this determination can be made based on the vehicle speed information and the position information, which have a relatively small amount of information, the amount of communication with the vehicles 100 can be reduced.

Then, when the first section is identified by the first section identification unit 301, the congested lane identification unit 302 obtains image data of the road captured from the vehicles 100 that have passed through the first section. The congested lane identification unit 302 requests the vehicles 100, which have transmitted the vehicle speed information or the like used when the first section identification unit 301 identified the first section, to transmit the image data. In this case, the vehicles 100 transmit to the server 300 the image data captured and stored in the auxiliary storage unit 13 at the time of traveling in the first section. Here, note that, as an alternative, the congested lane identification unit 302 may request the vehicles 100, which are about to enter the first section, to transmit the image data at the time of traveling in the first section. In this case, the congested lane identification unit 302 identifies the vehicles 100 that are about to enter the first section, based on the position information and the time information stored in the travel information DB 311. Further, the congested lane identification unit 302 generates a command for the vehicles 100, which are about to enter the first section, to obtain image data and upload it to the server 300, and transmits the command to the vehicles 100 to be targeted. Furthermore, as another alternative, the congested lane identification unit 302 may generate a command to the vehicles 100, which have already passed through the first section or are located within the first section, to upload the image data obtained by capturing the first section, and may transmit the command to the vehicles 100 to be targeted. In this case, the congested lane identification unit 302 identifies the vehicles 100 that have already passed through the first section or are located within the first section, based on the position information and the time information stored in the travel information DB 311.

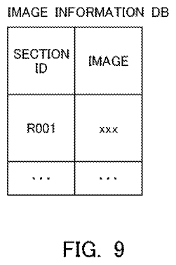

When obtaining the image data, the congested lane identification unit 302 stores the image data thus obtained in the auxiliary storage unit 33 and updates the image information DB 312. Here, FIG. 9 illustrates an example of a table structure of the image information DB 312. The image information table includes fields for section ID and image, respectively. In the section ID field, identification information for identifying each section of the road is entered. In the image field, information about the location where the image data has been stored is entered.

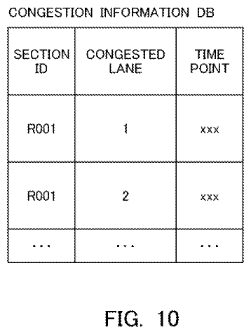

Upon obtaining the image data, the congested lane identification unit 302 performs image analysis to identify lanes in which traffic congestion is occurring. Known techniques can be used for this image analysis. Then, the congested lane identification unit 302 stores, in the congestion information DB 313, information about the lanes in which the traffic congestion is occurring. Here, FIG. 10 is a view illustrating an example of a table structure of the congestion information DB 313. A congestion information table includes fields for section ID, congested lane, and time, respectively. In the section ID field, identification information for identifying each section of the road is entered. In the congested lane field, information about a lane in which traffic congestion is occurring is entered. For example, the leftmost lane is designated as a first lane (i.e., numbered as 1), and each lane is subsequently numbered from the left side to the right side, and a congested lane number is entered in the congested lane field. In the time field, information about the time (i.e., time point) when traffic congestion occurs is entered.

When a lane in which traffic congestion is occurring is identified by the congested lane identification unit 302, the congestion information provision unit 303 provides congestion information. The congested lane identification unit 302, for example, transmits congestion information to the vehicles 100 that may pass through the first section. The vehicles 100 that may pass through the first section may be, for example, vehicles 100 that are located within a predetermined distance from the first section, or vehicles 100 that are traveling on the same road as the first section and whose direction of travel is in the direction of the first section. The congestion information provision unit 303 may transmit, to the navigation devices of the vehicles 100, a command to display the number of the congested lane or a command to illustrate the congested lane.

In addition, as an alternative, the congestion information provision unit 303 may provide congestion information to a display device (which may be a signage) for displaying congestion information placed on the road. In this case, a command may be transmitted so that the number of the congested lane is displayed on the display device or the congested lane is illustrated thereon.

Moreover, the map information DB 314 stores, as map information, link data related to roads (links), node data related to node points, intersection data related to each intersection, search data for searching routes, section data related to road sections, and lane data related to the number of lanes, etc.

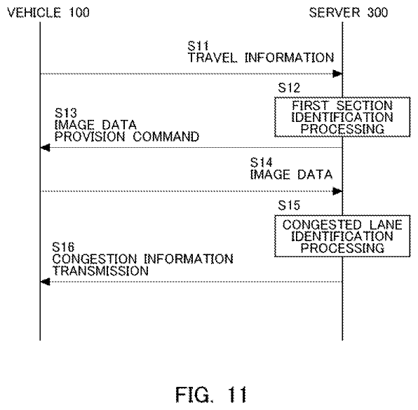

Then, the processing of the system 1 as a whole will be described. FIG. 11 is a sequence diagram illustrating the overall processing of the system 1. Travel information is transmitted from vehicles 100 to the server 300 at predetermined time intervals (S11). The processor 11 of each vehicle 100 transmits position information detected by the position information sensor 18, vehicle speed information detected by the vehicle speed sensor 19, and information about the time to the server 300, by associating these pieces of information with its vehicle ID. In the server 300, the first section identifying processing is executed at predetermined time intervals (S12). When a first section is identified by this first section identification processing, an image data provision command is transmitted to the vehicles 100 (S13). The image data provision command is a command for transmitting image data to the server 300. The image data provision command includes information about a time (i.e., time point). The image data provision command is a command to provide image data corresponding to this time point. Here, note that the vehicles 100 that have transmitted the travel information in S11 and the vehicles 100 that transmit the image data provision command in S13 do not have to be the same.

Image data is transmitted from each vehicle 100 that has received the image data provision command (S14). The processor 11 of each vehicle 100 extracts from the auxiliary storage unit 13 the image data corresponding to the time point indicated by the image data provision command, and transmits it to the server 300. Here, note that the processor 11 stores the image data in the auxiliary storage unit 13 in association with the time point. In the server 300, the congested lane identification processing is executed based on the image data (S15). When a congested lane is identified, congestion information is transmitted from the server 300 to the vehicles 100 (S16). Here, note that the vehicles 100 that have transmitted the travel information in S11, the vehicles 100 that transmit the image data provision command in S13, the vehicles 100 that transmit the congestion information in S16, do not have to be the same. The processor 11 of each vehicle 100, which has received the congestion information, displays, on its display 15, an image showing, for example, the congested section and the congested lane.

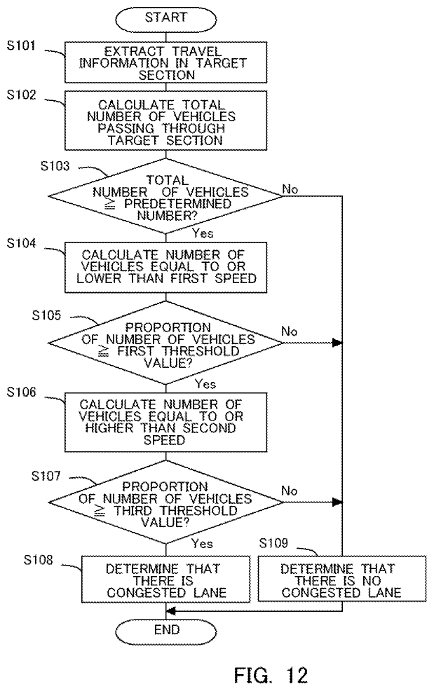

Next, the processing of identifying the first section in the server 300 (i.e., the first section identification processing) will be described. FIG. 12 is a flowchart illustrating the processing in which the server 300 identifies the first section. The processing of the flowchart illustrated in FIG. 12 is performed at predetermined time intervals at the server 300. Note that the following description will be made on the assumption that the travel information corresponding to a plurality of vehicles 100 has been stored in the travel information DB 311.

In step S101, the first section identification unit 301 extracts travel information in a target section. The target section is a section for which it is determined whether or not the section is the first section. The first section identification unit 301 extracts the vehicle IDs of the vehicles 100 that traveled through the target section, based on the location information stored in the travel information DB 311 and the information about the location of each of the sections stored in the map information DB 314. At this time, the vehicle IDs whose time points stored in the time field falls within a predetermined period of time are extracted. As a result, only the information that is considered to represent the current situation in the target section is used. The predetermined period of time is a period of time in which the vehicles 100 can take an image of the current situation in the target section. In step S102, the first section identification unit 301 calculates the total number of vehicles that have passed through the target section in the above-mentioned predetermined period of time. That is, the first section identification unit 301 calculates the total number of vehicle IDs extracted in step S101.

In step S103, the first section identification unit 301 determines whether or not the total number of vehicles 100 calculated in step S102 is equal to or greater than a predetermined number. The predetermined number is the number of vehicles 100 that would make it possible to determine that a part of the lanes is congested. For example, in cases where only one vehicle 100 has passed through the target section, it is difficult to determine whether or not a part of the lanes is congested. The predetermined number is, for example, 2, and has been stored in the auxiliary storage unit 33. When an affirmative determination is made in step S103, the processing proceeds to step S104, whereas when a negative determination is made, the processing proceeds to step S109, where the first section identification unit 301 determines that there is no traffic congestion in a part of the lanes. In step S109, the first section identification unit 301 determines that the target section does not correspond to the first section, by determining that there is no congestion in a part of the lanes in the target section.

In step S104, the first section identification unit 301 calculates the number of vehicles 100 whose speeds are equal to or lower than the first speed, among the vehicles 100 for which travel information has been extracted in step S101. The first speed has been stored in the auxiliary storage unit 33 as an upper limit value for the speeds of the vehicles 100 passing through a part of the lanes when traffic congestion is occurring in the part of the lanes. In step S105, the first section identification unit 301 determines whether or not the proportion of the number of vehicles 100 calculated in step S104 to the total number of vehicles 100 calculated in step S102 is equal to or greater than the first threshold value. The first threshold value is set as a lower limit value for the number of vehicles 100 passing through a part of the lanes in cases where traffic congestion is occurring in the part of the lanes. The first threshold value is, for example, equal to or greater than 1. When an affirmative determination is made in step S105, the processing proceeds to step S106, whereas when a negative determination is made, the processing proceeds to step S109.

In step S106, the first section identification unit 301 calculates the number of vehicles 100 whose speeds are equal to or higher than the second speed, among the vehicles 100 for which travel information has been extracted in step S101. The second speed has been stored in the auxiliary storage unit 33 as a lower limit value for the speeds of vehicles 100 passing through other lanes in which traffic congestion is not occurring, when traffic congestion is occurring in a part of the lanes. In step S107, the first section identification unit 301 determines whether or not the proportion of the number of vehicles 100 calculated in step S106 to the total number of vehicles 100 calculated in step S102 is equal to or greater than the second threshold value. In cases where traffic congestion is occurring in a part of the lanes, the second threshold value is set as a lower limit value for the number of vehicles 100 that pass through the lanes other than the part of the lanes. The second threshold value is, for example, equal to or greater than 1. When an affirmative determination is made in step S107, the processing proceeds to step S108, whereas when a negative determination is made, the processing proceeds to step S109. Then, in step S108, the first section identification unit 301 determines that there is traffic congestion in a part of the lanes. That is, it is determined that the target section is the first section. Thus, the first section is identified. On the other hand, in step S109, the first section identification unit 301 determines that there is no traffic congestion in a part of the lanes. The determination that there is no traffic congestion in a part of the lanes is made, either when there is no traffic congestion at all in the target section, or when there is traffic congestion in all of the lanes in the target section.

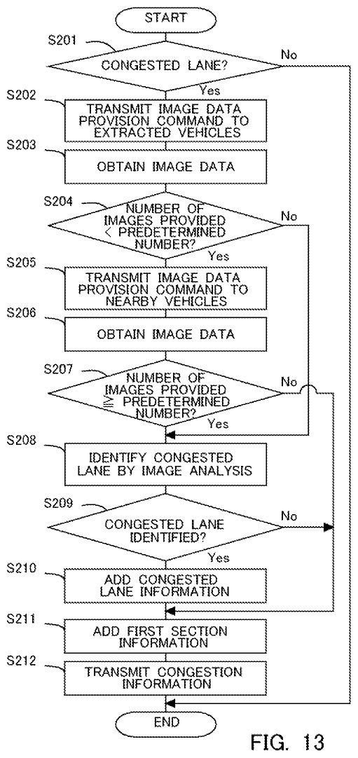

Next, the processing of identifying a congested lane in the server 300 (i.e., congested lane identification processing) will be described. FIG. 13 is a flowchart illustrating the processing of identifying a congested lane by the server 300. The processing of the flowchart illustrated in FIG. 13 is performed at predetermined time intervals at the server 300. Here, note that, as an alternative, the processing of the flowchart in FIG. 13 may be executed after the processing of step S108 in the flowchart illustrated in FIG. 12. The following description will be made on the assumption that the travel information corresponding to a plurality of vehicles 100 has been stored in the travel information DB 311.

In step S201, the congested lane identification unit 302 determines whether or not a congested lane is present in the target section. That is, in step S108 of the flowchart illustrated in FIG. 12, it is determined whether or not the first section identification unit 301 has determined that there is a congested lane. When an affirmative determination is made in step S201, the processing or routine proceeds to step S202, whereas when a negative determination is made, this routine is ended.

In step S202, the congested lane identification unit 302 transmits an image data provision command to the vehicles 100 (also referred to as extracted vehicles) whose travel information has been extracted in step S101. The image data provision command includes, for example, information about a time. This time is a time point at which the vehicles 100 were traveling in the first section. This time is also a time point included in the predetermined period of time described in the above-mentioned step S101. The processor 11 of each vehicle 100 extracts image data corresponding to this time point from the auxiliary storage unit 13, and transmits it to the server 300 in association with its vehicle ID.

In step S203, the congested lane identification unit 302 obtains the image data from each vehicle 100. This image data is stored in the auxiliary storage unit 33 in association with each vehicle ID. Then, the image information DB 312 is updated by entering the storage location of the image data in the image field of the image information DB 312. A plurality of pieces of image data are obtained from the plurality of vehicles 100. In step S204, the congested lane identification unit 302 determines whether or not the number of images provided is less than a predetermined number. The number of images provided may be the number of vehicles 100 that have provided the image data. The predetermined number is a lower limit value of the number of pieces of image data required to identify a congested lane. When an affirmative determination is made in step S204, the processing proceeds to step S205, whereas when a negative determination is made, the processing proceeds to step S208.

In step S205, the congested lane identification unit 302 transmits an image data provision command to the vehicles 100 around the first section. This image data provision command includes, for example, a command to transmit information about the time point and image data corresponding to the time point to the server 300. The vehicles 100 around the first section to which the image data provision command is to be transmitted may be any of the following: vehicles 100 that are about to enter the first section, vehicles 100 that are currently traveling in the first section, and vehicles 100 that have traveled through the first section in the past. In addition, the image data provision command may be transmitted to all the vehicles 100 present within the predetermined distance from the first section regardless of whether or not they pass through the first section. At this time, the image data provision command may be broadcast.

Here, note that the vehicles 100 that are about to enter the first section may be the vehicles 100 whose courses are heading toward the first section. The courses of the vehicles 100 may be determined from the position information of the vehicles 100, or may be determined by obtaining routes set in the navigation devices of the vehicles 100. In addition, the vehicles 100 that are about to enter the first section may be the vehicles 100 that are expected to enter the first section within a predetermined period of time. In other words, it is difficult to provide image data for identifying a congested lane unless the vehicles 100 are capable of capturing traffic congestion in a part of the lanes that is occurring at the current time point, and hence, the vehicles 100 that are expected to enter the first section immediately may be extracted. For example, the vehicles 100 traveling in a section adjacent to the first section may be extracted.

In addition, the vehicles 100 currently traveling in the first section may be the vehicles 100 whose current positions indicated by their position information are present on the first section. Further, the vehicles 100 that have traveled through the first section in the past are the vehicles 100 that can provide images for identifying a congested lane that is occurring at the current time point. For example, image data captured by the camera 17 may be stored in the auxiliary storage unit 13 for a certain period of time. In this way, the vehicles 100 whose image data at the time of traveling in the first section have been stored are extracted. For example, the vehicles 100 whose positions indicated by their position information in the past are present on the first section may be extracted. Here, note that the vehicles 100 that have traveled through the first section in the past may be the vehicles 100 that have left the first section within a predetermined period of time. In other words, it is difficult to provide image data for identifying a congested lane unless the vehicles 100 have captured traffic congestion in a part of the lanes that is occurring at the current time point, and hence, the vehicles 100 that have left the first section not so long ago may be extracted. For example, the vehicles 100 that have left the first section and are traveling in a section adjacent to the first section may be extracted.

In step S206, the congested lane identification unit 302 obtains the image data from each vehicle 100. Then, the image information DB 312 is updated by entering the storage location of the image data in the image field of the image information DB 312. In step S207, the congested lane identification unit 302 determines whether or not the number of images provided is equal to or greater than a predetermined number. The number of images provided referred to herein is a total value of the number of pieces of image data obtained in step S203 and the number of pieces of image data obtained in step S206. In addition, the predetermined number here is the same as the predetermined number in step S204. When an affirmative determination is made in step S207, the processing proceeds to step S208, whereas when a negative determination is made, the processing proceeds to step S211.

In step S208, the congested lane identification unit 302 performs image analysis to identify a congested lane. Known techniques can be used for the image analysis. In step S209, the congested lane identification unit 302 determines whether or not a congested lane has been identified. For example, if the image data does not contain information that can identify a congested lane, it may not be possible to identify the congested lane. When an affirmative determination is made in step S209, the processing proceeds to step S210, whereas when a negative determination is made, the processing proceeds to step S211.

In step S210 and step S211, the congestion information provision unit 303 generates congestion information. In step S210, information about the congested lane is added to the congestion information. In step S211, information about the first section is added to the congestion information. For example, even if the congested lane cannot be identified, it is possible to notify that a part of the lanes is congested in the first section because it has been already identified that a part of the lanes is congested. In step S212, the congestion information provision unit 303 transmits the congestion information to the vehicles 100. At this time, the congestion information provision unit 303 may transmit the congestion information to vehicles 100 present within a predetermined distance from the first section, for example. The predetermined distance is set as a distance that may be affected by traffic congestion. Here, note that the congestion information may be broadcast. In addition, as an alternative, the congestion information may be transmitted, as information for displaying the first section and the congestion lane, to a display device that is arranged on the road so as to guide congested locations. The congestion information may include a command to display the first section and the congested lane on the display 15 of each vehicle 100 or on a display device set up on the road. In this way, the congestion information is distributed.

As described above, according to the present embodiment, it is possible to provide vehicles 100 with information about a congested section and a congested lane. Conventionally, it was possible to identify a congested section, but it was difficult to identify a congested lane when a part of lanes was congested. In addition, if image data is constantly obtained from all the vehicles 100, for example, in an attempt to identify a congested lane, the amount of communication traffic becomes enormous. Also, in cases where the image data captured at each vehicle 100 has been stored in a memory as local data, it may be difficult to detect a congested lane in real time. On the other hand, according to the present embodiment, it is sufficient to obtain the image data corresponding to the first section, so that the amount of communication traffic can be reduced. That is, by obtaining the image data corresponding to the first section after identifying the first section in which a part of the lanes is congested based on the data of a small volume from sensors, the amount of communication traffic at the time of transmitting the image data to the server 300 can be reduced. Moreover, the first section and the congested lane can be detected in real time. Further, since the first section can be identified based on the position information and the speed information of the vehicles, existing information can be used to identify the first section.

### Second Embodiment

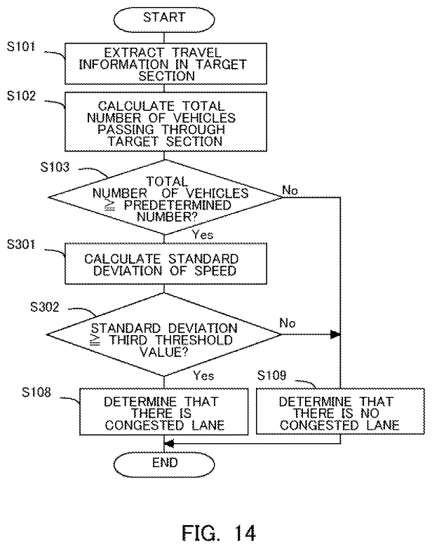

In a second embodiment, based on the standard deviation of the speeds of a plurality of vehicles 100, it is determined whether or not there is traffic congestion in a part of lanes. The standard deviation of the speeds of the plurality of vehicles 100 is an example of the variation of speeds in the plurality of vehicles. As an alternative, it may be possible to determine whether or not a part of lanes is congested, based on the dispersion of the speeds of the plurality of vehicles 100, or based on another index representing the variation of the speeds of the plurality of vehicles 100. FIG. 14 is a flowchart illustrating the processing of identifying the first section by the server 300. The processing of the flowchart illustrated in FIG. 14 is performed at predetermined time intervals at the server 300. Note that the following description will be made on the assumption that the travel information corresponding to a plurality of vehicles 100 has been stored in the travel information DB 311. Here, note that steps in which the same processing as in FIG. 12 is executed will be denoted by the same reference signs, and the description thereof will be omitted.

In the flowchart illustrated in FIG. 14, when an affirmative determination is made in step S103, the processing proceeds to step S301. In step S301, the first section identification unit 301 calculates the standard deviation of the speeds of the plurality of vehicles 100 in the target section extracted in step S101. For example, the speed of each vehicle 100 at any position in the target section may be extracted from the travel information DB 311 to calculate the standard deviation. Alternatively, the average speed of each vehicle 100 in the first section may be calculated, and the standard deviation corresponding to the average speeds of all the vehicles may be calculated. In this step S301, the standard deviation is calculated which serves as an index of the variation of the speeds of the plurality of vehicles 100.

In step S302, the first section identification unit 301 determines whether or not the standard deviation calculated in step S301 is equal to or greater than a third threshold value. The third threshold value is a lower limit value of the standard deviation at the time when traffic congestion is occurring in a part of lanes, and has been stored in the auxiliary storage unit 33. When an affirmative determination is made in step S302, the processing proceeds to step S108, whereas when a negative determination is made, the processing proceeds to step S109. When it is determined in step S108 that there is a lane in which traffic is congested, the congested lane is identified by the routine illustrated in FIG. 13.

As described above, according to the present embodiment, it is possible to determine, based on the variation of the speeds of a plurality of vehicles 100, whether or not traffic congestion is occurring in a part of the lanes.

### OTHER EMBODIMENTS

The above-described embodiments are merely examples, but the present invention can be implemented with appropriate modifications without departing from the spirit thereof.

The processing and/or means (devices, units, etc.) described in the present disclosure can be freely combined and implemented as long as no technical contradiction occurs.

The processing described as being performed by one device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner.

The present invention can also be realized by supplying to a computer a computer program in which the functions described in the above-described embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus comprising a controller configured to perform:
identifying, based on position information and speed information of each vehicle obtained from a plurality of vehicles traveling on a road having a plurality of lanes, a first section that is a section where a part of the plurality of lanes is congested;
obtaining image data that has captured the first section thus identified; and
identifying, based on the image data, a lane that is congested in the first section.

2. The information processing apparatus according to claim 1, wherein
the controller is configured to perform:
identifying, as the first section, a section in which a proportion of the number of vehicles whose vehicle speeds are equal to or lower than a first speed is equal to or greater than a first threshold value and in which a proportion of the number of vehicles whose vehicle speeds are equal to or higher than a second speed is equal to or greater than a second threshold value, among the plurality of vehicles traveling on the road.

3. The information processing apparatus according to claim 1, wherein
the controller is configured to perform:
identifying, as the first section, a section in which a variation of speeds in the plurality of vehicles traveling on the road is equal to or greater than a third threshold value.

4. The information processing apparatus according to claim 1, wherein
the controller is configured to perform:
receiving the image data that has captured the first section from a vehicle that has traveled through the first section.

5. The information processing apparatus according to claim 4, wherein
the controller is configured to perform:
transmitting, to a vehicle that has traveled through the first section in the past, a command to provide image data that has been captured in the first section and stored in a memory of the vehicle.

6. The information processing apparatus according to claim 4, wherein
the controller is configured to perform:
transmitting, to a vehicle that is about to travel in the first section, a command to take an image in the first section and provide the image data.

7. The information processing apparatus according to claim 1,
wherein
the controller is configured to perform:
distributing information about the first section identified and information about the congested lane.

8. An information processing method for causing a computer to perform:
identifying, based on position information and speed information of each vehicle obtained from a plurality of vehicles traveling on a road having a plurality of lanes, a first section that is a section where a part of the plurality of lanes is congested;
obtaining image data that has captured the first section thus identified;
identifying, based on the image data, a lane that is congested in the first section.

9. The information processing method according to claim 8, wherein
the computer is configured to perform:
identifying, as the first section, a section in which a proportion of the number of vehicles whose vehicle speeds are equal to or lower than a first speed is equal to or greater than a first threshold value and in which a proportion of the number of vehicles whose vehicle speeds are equal to or higher than a second speed is equal to or greater than a second threshold value, among the plurality of vehicles traveling on the road.

10. The information processing method according to claim 8, wherein
the computer is configured to perform:
identifying, as the first section, a section in which a variation of speeds in the plurality of vehicles traveling on the road is equal to or greater than a third threshold value.

11. The information processing method according to claim 8, wherein
the computer is configured to perform:
receiving the image data that has captured the first section from a vehicle that has traveled through the first section.

12. The information processing method according to claim 11, wherein
the computer is configured to perform:
transmitting, to a vehicle that has traveled through the first section in the past, a command to provide image data that has been captured in the first section and stored in a memory of the vehicle.

13. The information processing method according to claim 11, wherein
the computer is configured to perform:
transmitting, to a vehicle that is about to travel in the first section, a command to take an image in the first section and provide the image data.

14. The information processing method according to claim 8, wherein
the computer is configured to perform:
distributing information about the first section identified and information about the congested lane.

15. A system comprising:
a plurality of vehicles configured to transmit their position information and speed information; and
a server configured to receive the position information and the speed information from the plurality of vehicles; wherein
the server is configured to perform:
identifying, based on the position information and the speed information of each vehicle obtained from the plurality of vehicles traveling on a road having a plurality of lanes, a first section that is a section where a part of the plurality of lanes is congested;
transmitting, to the plurality of vehicles, a command to provide image data that has captured the first section thus identified;
obtaining the image data from the plurality of vehicles; and
identifying a congested lane in the first section based on the image data.

16. The system according to claim 15, wherein
the server is configured to perform:
identifying, as the first section, a section in which a proportion of the number of vehicles whose vehicle speeds are equal to or lower than a first speed is equal to or greater than a first threshold value and in which a proportion of the number of vehicles whose vehicle speeds are equal to or higher than a second speed is equal to or greater than a second threshold value, among the plurality of vehicles traveling on the road.

17. The system according to claim 15, wherein
the server is configured to perform:
identifying, as the first section, a section in which a variation of speeds in the plurality of vehicles traveling on the road is equal to or greater than a third threshold value.

18. The system according to claim 15, wherein
the server is configured to perform:
receiving the image data that has captured the first section from a vehicle that has traveled through the first section.

19. The system according to claim 18, wherein
the server is configured to perform:
transmitting, to a vehicle that has traveled through the first section in the past, a command to provide image data that has been captured in the first section and stored in a memory of the vehicle.

20. The system according to claim 18, wherein
the server is configured to perform:
transmitting, to a vehicle that is about to travel in the first section, a command to take an image in the first section and provide the image data.
